(19) United States
(12) Patent Application Publication
(10) Pub. No.: US 2015/0120445 A1
(43) Pub. Date: Apr. 30, 2015

(54) USER SUSCEPTIBILITY PROFILES IN MARKETPLACE ENVIRONMENTS

(71) Applicant: Steven Romero, Portland, OR (US)

(72) Inventor: Steven Romero, Portland, OR (US)

(73) Assignee: EBAY INC., SAN JOSE, CA (US)

(21) Appl. No.: 14/066,016

(22) Filed: Oct. 29, 2013

(51) Int. Cl. G06Q 30/02

(52) U.S. Cl. CPC G06Q 30/0256
USPC 705/14.54

(57) ABSTRACT

Systems, methods and media for susceptibility profiles in a marketplace environment are disclosed. In one example, a method comprises collecting transaction data relating to a plurality of participants performing transactions in a marketplace environment and identifying at least one transaction driver associated with an identified section of the transactions. Based on the identified at least one transaction driver, a susceptibility profile is created for a participant in the marketplace environment, the susceptibility profile including participant-related data pertaining to the at least one identified transaction driver. A request may be received from the marketplace participant to search for an item for sale in the marketplace environment. A presentation to the participant of items for sale satisfying the susceptibility profile of the participant may be made.

### TECHNICAL FIELD

The present application relates generally to the technical field of marketplace environments, and in particular electronic shopping. In various embodiments, systems, methods and media are provided for promoting electronic shopping transactions and sales conversion.

### BACKGROUND

Electronic commerce (e-commerce) sites are configured to offer for sale one or more items and provide virtual shopping carts to facilitate purchase of such items. A user visiting an e-commerce site can place one or more items of interest into a virtual shopping cart, and proceed to a checkout process once he or she is ready to purchase the item(s) placed in the cart. Once the user has completed the checkout process, the e-commerce site processes the purchase order to obtain payment and ship the purchased items to the user or hold the purchased items for pick up.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network diagram depicting an example system for providing and using susceptibility profiles, in accordance with some embodiments;

FIG. 2 illustrates a block diagram of additional details of the example system of FIG. 1, in accordance with some embodiments;

FIG. 3 illustrates a network diagram depicting an example system for providing and using susceptibility profiles, in accordance with some embodiments;

FIG. 4 illustrates a graphical user interface displaying stages of an online shopping experience, in accordance with some embodiments;

FIG. 5 is a flowchart illustrating a method, in accordance with some embodiments; and

FIG. 6 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail. In this specification the terms “user” and “participant” are used interchangeably unless the context indicates otherwise.

In some embodiments, a susceptibility profile is created for a marketplace participant or user based on how that individual responds or reacts to something that is positioned to them. For example, some users may be very attracted to items offered for sale that include free shipping as an associated service. These users are thus “susceptible” to buying items offered in this manner. The free shipping example as an aspect of susceptibility for a given user can thus be said to be a transaction driver. A user may have many areas of susceptibility including, as another example, a price discount threshold. In this case, a user may be attracted to (and purchase) only items that are offered for sale at a 50% discount off retail price, for example. In some embodiments, a susceptibility profile is thus created for a user based on an identification of those aspects that encourage that user to complete a transaction and “convert” a product offer into a purchase. The discount threshold is illustrative of how a user may react to an offer or, in other words, respond to something positioned to them.

It will be appreciated that many different user-specific responses to offers are possible, especially when such responses are viewed across many millions of users in marketplace environments stretching around the globe. Capture of such user-specific information can be a significant challenge, particularly when such capture must comply with data privacy laws.

In some examples, a susceptibility profile can include user-related (user-specific) data pertaining to many different aspects or transaction drivers. These aspects (transaction drivers) can include pricing thresholds. For example, a user may be susceptible to purchasing items costing less than $10. Another aspect may be a discount threshold. For example, a review of browsing history may reveal that a user typically completes a transaction when items for sale are offered at discounts of 20% or more. The user is therefore susceptible to buying items included in such offers. Other examples can include a budget limit, or a delivery service (for example, free shipping mentioned above), or an available or running balance at a payment service provider (for example, $105.30 dollars at PayPal, or a similar value in coupons, or points). In this example, a user's susceptibility may be based on a limited ability to purchase goods within an available balance. The susceptibility profile of this user may include this aspect (driver) such that searches for or the presentation of items for sale is limited to goods or services costing less than this value.

Another driver might be related to a user payment cycle. Here, a user might be more susceptible to purchasing goods after a salary payment at the end of a calendar month, for example. Another driver might relate to geographic location. For example, a user might be susceptible to buying items offered for sale in California, or manufactured in Bermuda, or within 5 miles of a school address, for example. In some examples, this information is included or coded appropriately in a user's susceptibility profile. In other examples, this aspect is included in the user's profile along with many other aspects that might make up a user's full susceptibility profile. Specific product or service configurations might also constitute transaction drivers, and preference data pertaining to such aspects might also form part of a user's susceptibility profile. Other user-related data can include requests to remove items from a shopping cart, or feedback received regarding an item previously purchased, and so forth. Other aspects of a user's online or in-store browsing history are possible.

In some examples, an online marketplace may include listings of items for sale for which the seller requires a minimum price, for example to cover costs. In some examples, the controller of the online marketplace creates (or otherwise acquires) an extensive suite of susceptibility profiles for millions of participants in that market (for example, per sector, per country, or globally) and may offer the seller an enhanced listing service that makes use of these susceptibility profiles. Usually, the seller will want to sell the items at a price in excess of the minimum price and in an ideal case at a full or “premium” price to maximize returns. Further, the seller will usually want to offer the items listed for sale to as wide a target market as possible. In marketplace environments including millions of market participants, the use of pre-created susceptibility profiles can be extremely useful in promoting the conversion of sales. The susceptibility profiles can be tailored to address certain sections of the market. Items offered for sale can be listed by the marketplace controller at prices which encourage the purchase by other users (buyers) based on the susceptibility profiles created for those potential buyers. In the event that use of the susceptibility profiles “converts” sales for the seller at prices in excess of a minimum, the excess funds derived (i.e., based on the difference between the minimum price and the actual selling price) can be apportioned between the seller and marketplace controller, accordingly. An agreed portion of the excess funds directed to the controller might be based on use of the susceptibility profiles, accordingly.

Thus, in some embodiments, a method comprises collecting transaction data relating to a plurality of participants performing transactions in a marketplace environment; identifying at least one transaction driver associated with an identified section of the transactions; based on the identified at least one transaction driver, creating a susceptibility profile for a participant in the marketplace environment, the susceptibility profile including participant-related data pertaining to the at least one identified transaction driver; receiving a request from the participant to search for an item for sale in the marketplace environment; and causing a presentation to the participant of items for sale satisfying the susceptibility profile of the participant.

In some examples, the susceptibility profile of the participant includes participant-related data pertaining to one or more of: a price threshold; a discount threshold; a budget limit; a delivery service; an available balance at a payment service provider; a payment cycle; a geographic location; a product or service configuration; a request to remove an item from a shopping cart; feedback received regarding an item previously purchased; and, a browsing history.

In some examples, the method of claim 1 further comprises receiving a request from a first participant to place an item for sale in the marketplace environment; receiving from the first participant a minimum price for the item; causing a presentation of the item in the marketplace environment at a sales price based on the susceptibility profile of at least one second participant; receiving a request from the at least one second participant to purchase the item; and apportioning a payment to the first participant based on a portion or all of a difference between the sales price and the minimum price.

In some embodiments, a system may comprise a machine and a susceptibility profile module. The machine may have a memory and at least one processor. The machine including the susceptibility module may be configured to perform the operations, functions, and method steps discussed within the present disclosure.

In some embodiments, a non-transitory machine-readable medium may include a set of instructions that, when executed by at least one processor, causes the at least one processor to perform the operations, functions, and method steps discussed within the present disclosure.

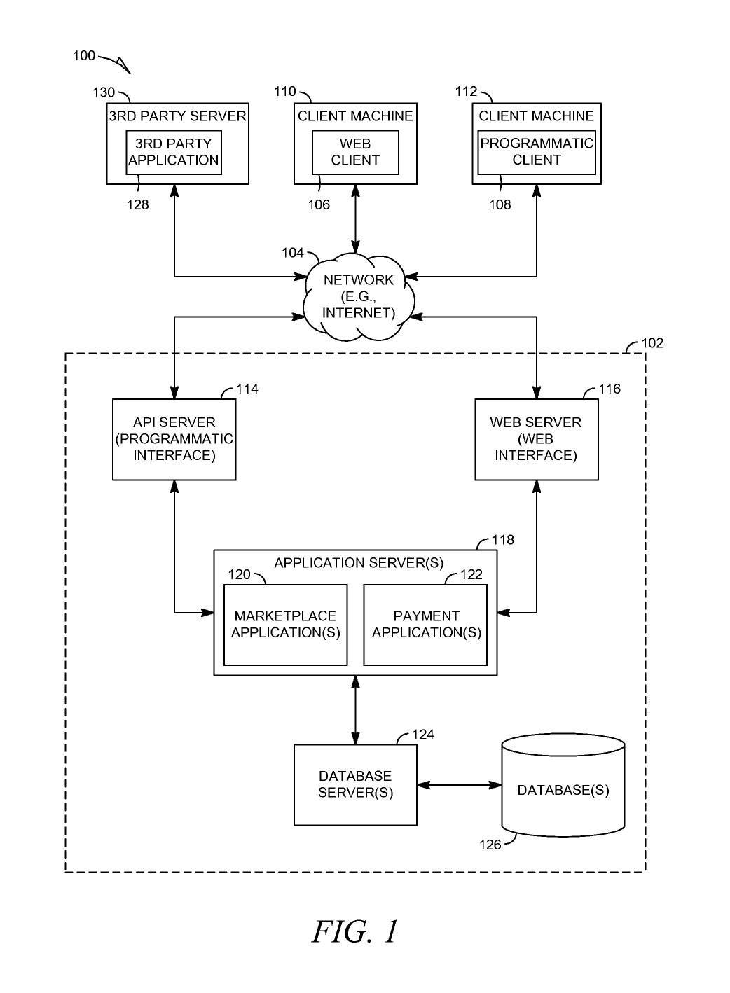

Turning now to the accompanying drawings, FIG. 1 illustrates a network diagram depicting an example publication system 100 for facilitating checkout of item(s) in a virtual shopping cart provided by an electronic commerce (e-commerce) environment according to some embodiments. A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on client machines 110 and 112. In one embodiment, the publication system 100 comprises a marketplace system. In another embodiment, the publication system 100 comprises other types of systems such as, but not limited to, a social networking system, a matching system, an electronic commerce (e-commerce) system, and the like.

Each of the client machines 110, 112 comprises a computing device that includes at least a display and communication capabilities with the network 104 to access the networked system 102. The client machines 110, 112 comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client machines 110, 112 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client machines 110, 112 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client machines 110, 112, then this application is configured to locally provide the user interface and at least some of the functionalities with the application configured to communicate with the networked system 102, on an as needed basis, for data and/or processing capabilities not locally available (such as access to a database of items available for sale, to authenticate a user, to verify a method of payment, etc.). Conversely if the e-commerce site application is not included in a given one of the client machines 110, 112, the given one of the client machines 110, 112 may use its web browser to access the e-commerce site (or a variant thereof) hosted on the networked system 102. Although two client machines 110, 112 are shown in FIG. 1, more or less than two client machines can be included in the publication system 100.

An Application Program Interface (API) server 114 and a web server 116 are coupled to, and provide programmatic and web interfaces respectively to, one or more application servers 118. The application servers 118 host one or more marketplace applications 120 and payment applications 122. The marketplace applications 120 can include susceptibility profile applications. The application servers 118 are, in turn, shown to be coupled to one or more database servers 124 that facilitate access to one or more databases 126.

The marketplace applications 120 may provide a number of e-commerce functions and services to users that access networked system 102. E-commerce functions/services may include a number of publisher functions and services (e.g., search, listing, content viewing, payment, etc.). For example, the marketplace applications 120 may provide a number of services and functions to users for listing goods and/or services or offers for goods and/or services for sale, searching for goods and services, facilitating transactions, and reviewing and providing feedback about transactions and associated users. Additionally, the marketplace applications 120 may track and store data and metadata relating to listings, transactions, and user interactions. The data can include susceptibility data including the user-specific data pertaining to the transaction drivers discussed in this specification. In some embodiments, the marketplace applications 120 may publish or otherwise provide access to content items stored in application servers 118 or databases 126 accessible to the application servers 118 and/or the database servers 124. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. The payment applications 122 may regulate payment to sellers for goods and/or services sold in the marketplace and direct a portion of the sales proceeds to a marketplace controller for use of susceptibility profiles for boosting the conversion of sales.

While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the publication system 100. In some embodiments, at least a portion of the marketplace applications 120 may be provided on the client machines 110 and/or 112.

Further, while the publication system 100 shown in FIG. 1 employs a client-server architecture, embodiments of the present disclosure are not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

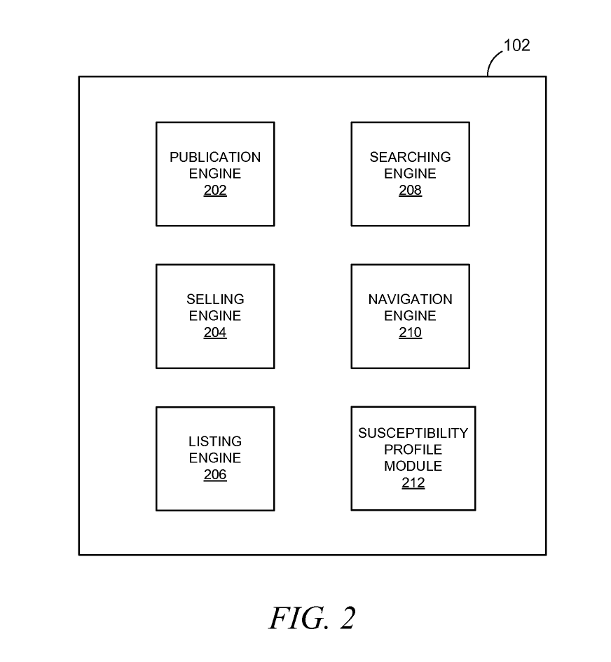

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the data servers 128.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking. In some embodiments, the selling engine 204 or the listing engine 206 allows a user to request use of susceptibility profiles in offering the listed items for sale in the marketplace.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., client machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

In some embodiments, a susceptibility profile module 212 may be configured to create and implement the susceptibility profile functions and methods described in this specification. The susceptibility profile module 212 may also be configured to manage a susceptibility profile comprising information regarding shopping preferences of the user, transaction drivers for that user, update the susceptibility profile of the user, and determine one or more details of an item to be presented to a user as a product offering based on the susceptibility profile of the user. It is contemplated that the susceptibility profile module 212 may be further configured to provide or perform any of the other features, functions, or operations disclosed herein.

Additional modules and engines associated with the networked system 102 are described below in further detail. It should be appreciated that modules or engines may embody various aspects of the details described below.

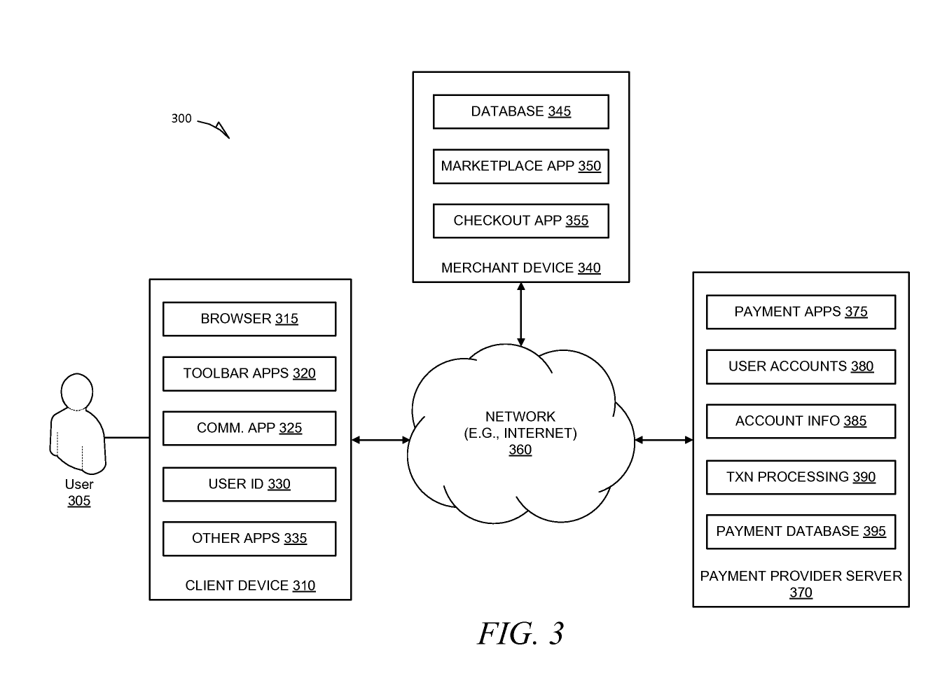

FIG. 3 is a block diagram of a networked system 300 configured to handle processes, such as described herein, in accordance with some embodiments. System 300 includes a client device 310, a merchant device (e.g., server) 340, and a payment provider server 370 in communication over a network 360. Payment provider server 370 may be maintained by a service or payment provider, such as Pay Pal, Inc. or eBay, Inc. of San Jose, Calif. A user 305, such as a consumer, may utilize client device 310 to make a purchase transaction facilitated by payment provider server 370, with one or more merchants.

Client device 310, merchant device 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

Client device 310 may be implemented using any appropriate hardware and software configured for wired and/or wireless communication over network 360. For example, in one embodiment, the client device 310 may be implemented as a personal computer (PC), a smart phone, personal digital assistant (PDA), laptop computer, and/or other types of computing devices capable of transmitting and/or receiving data, such as an iPad™ from Apple™.

Client device 310 may include one or more browser applications 315 which may be used, for example, to provide a convenient interface to permit user 305 to browse information available over network 360. For example, in one embodiment, browser application 315 may be implemented as a web browser configured to view information available over the Internet or access a website of the payment provider. Client device 310 may also include one or more toolbar applications 320 which may be used, for example, to provide client-side processing for performing desired tasks in response to operations selected by user 305. In some embodiments, toolbar application 320 may display a user interface in connection with browser application 315.

Client device 310 may further include other applications 335 as may be desired in particular embodiments to provide desired features to client device 310. For example, other applications 335 may include security applications for implementing client-side security features, programmatic client applications for interfacing with appropriate application programming interfaces (APIs) over network 360, or other types of applications. Applications 335 may also include email, texting, voice and IM applications that allow user 305 to send and receive emails, calls, texts, and other notifications through network 360. Client device 310 may include one or more user identifiers 330 which may be implemented, for example, as operating system registry entries, cookies associated with browser application 315, identifiers associated with hardware of client device 310, or other appropriate identifiers, such as used for payment/user/device authentication or identification. In some embodiments, user identifier 330 may be used by a payment service provider to associate user 305 with a particular account maintained by the payment provider. A communications application 325, with associated interfaces, enables client device 310 to communicate within system 300.

Merchant device 340 may be maintained, for example, by a merchant or seller offering various items, products and/or services through an online site or app. Generally, merchant device 340 may be maintained by anyone or any entity that receives money, which includes charities as well as retailers and restaurants. Merchant device 340 may include a database 345 identifying available products and/or services (e.g., collectively referred to as items), which may be made available for viewing and purchase by user 305. Merchant device 340 may also include a marketplace application 350 which may be configured to serve information over network 360 to browser application 315 of client device 310 and/or payment provider server 370. In one embodiment, user 305 may interact with marketplace application 350 to view various items available for purchase from the merchant.

Merchant device 340 may also include a checkout application 355 which may be configured to facilitate the purchase by user 305 of goods or services identified by marketplace application 350. Checkout application 355 may be configured to accept payment information from or on behalf of user 305 through payment provider server 370 over network 360. For example, checkout application 355 may receive and process a payment confirmation from payment provider server 370, as well as transmit transaction information to the payment provider and receive information from the payment provider (e.g., a transaction ID). Checkout application 355 may also be configured to accept one or more different funding sources for payment.

Payment provider server 370 may be maintained, for example, by an online service provider which may provide payment between user 305 and the operator of merchant device 340. In this regard, payment provider server 370 includes one or more payment applications 375 which may be configured to interact with client device 310 and merchant device 340 over network 360 to facilitate the purchase of goods or services by user 305 of client device 310 as well as search merchant offerings and prices as discussed above.

Payment provider server 370 may also maintain a plurality of user accounts 380, each of which may include account information 385 associated with individual users. For example, account information 385 may include susceptibility profile data or private financial information of users of devices such as account numbers, passwords, device identifiers, user names, phone numbers, credit card information, bank information, or other financial information which may be used to facilitate online transactions by user 305. Account information 385 may also include information associated with the payment process described herein. Advantageously, payment application 375 may be configured to interact with merchant device 340 on behalf of user 305 during a transaction with checkout application 355 to handle payments.

A transaction processing application 390, which may be part of payment application 375 or separate, may be configured to receive information from a client device 310 and/or merchant device 340 for processing and storage in a payment database 395 as described above. Transaction processing application 390 may include one or more applications to process information from user 305 and/or the merchant for processing a transaction from client device 310 as described herein. As such, transaction processing application 390 may store details of a transaction or from an email and associate the details accordingly for individual users. The transaction processing application 390 may also regulate payments between a user and a marketplace controller, based for example on use by the user of the stored susceptibility profiles. Payment application 375 may be further configured to determine the existence of and to manage accounts for user 305, as well as create new accounts if needed, performing tasks such as set-up, management, and providing various services as described herein.

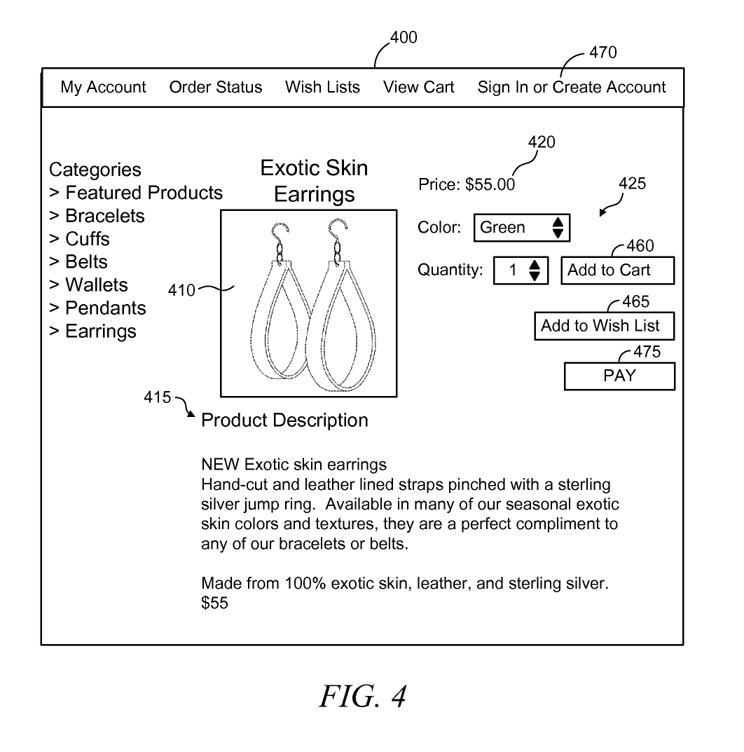

FIG. 4 illustrates a graphical user interface 400 displaying stages of an online shopping experience, in accordance with some embodiments. In FIG. 4, the graphical user interface 400 displays an item page showing an item being offered for sale on an e-commerce website. The search for, identification of, or presentation of the item offered for sale may be based on a susceptibility profile for the user viewing the item page. Information related to the item for sale may be displayed on the item page. Such information may include, but is not limited to, one or more item identifiers 410 (e.g., an image of the item, a name/title of the image), a description 415 of the item, and a price 420 of the item. The graphical user interface 400 may also display one or more selectable details 425 of the item. Such selectable details 425 may include, but are not limited to, color of the item, quantity of the item, and size of the item. A variety of user interface elements may be employed to enable the user to make selections regarding the selectable details 425. Such user interface elements include, but are not limited to, drop-down menus and radio buttons. Some elements may include Sign In or Create Account element 470, Add to Wish List element 465 and Pay element 475. Other user interface elements are also within the scope of the present disclosure.

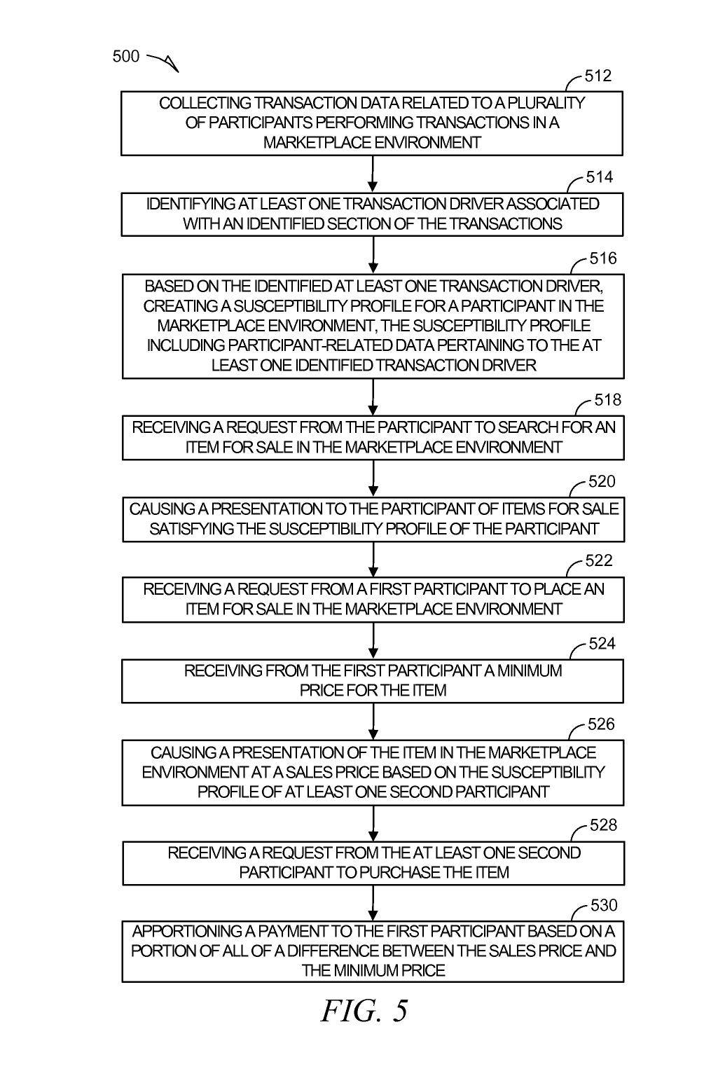

FIG. 5 is a flowchart illustrating a method 500 including use of susceptibility profiles, in accordance with some embodiments. The operations of the method 500 may be performed by the client machine 110, client machine 112, and/or a server included in the networked system 102 (e.g., API server 114, web server 116, or application servers 118). The operations may be performed by modules (e.g., susceptibility profile module 212). The various operations of the method 500 may be performed in different orders, and the method 500 may include only some of the operations described below.

The method 500 may comprise, at operation 512, collecting transaction data relating to a plurality of participants performing transactions in a marketplace environment; at operation 514, identifying at least one transaction driver associated with an identified section of the transactions; at operation 516, based on the identified at least one transaction driver, creating a susceptibility profile for a participant in the marketplace environment, the susceptibility profile including participant-related data pertaining to the at least one identified transaction driver; at operation 518, receiving a request from the participant to search for an item for sale in the marketplace environment; and at operation 520, causing a presentation for the participant of items for sale satisfying the susceptibility profile of the participant.

In some embodiments, the susceptibility profile of the participant includes participant-related data pertaining to one or more of: a price threshold; a discount threshold; a budget limit; a delivery service; an available balance at a payment service provider; a payment cycle; a geographic location; a product or service configuration; a request to remove an item from a shopping cart; feedback received regarding an item previously purchased; and a browsing history.

In some embodiments, the method 500 further comprises, at operation 522, receiving a request from a first participant to place an item for sale in the marketplace environment; at operation 524, receiving from the first participant a minimum price for the item; at operation 526, causing a presentation of the item in the marketplace environment at a sales price based on the susceptibility profile of at least one second participant; at operation 528, receiving a request from the at least one second participant to purchase the item; and, at operation 530, apportioning a payment to the first participant based on a portion or all of a difference between the sales price and the minimum price.

These and other variations in the performance of the flow diagram 500 are within the scope of embodiments of the present disclosure.

### Additional Details and Features

In some embodiments, a service is provided to a user or consumer that enables an enhanced online shopping experience. In various embodiments, the user may select an item of interest, save it for a specific occasion/category, and share all saved items in the category to a closed group or open group of other users. The user may share a list of one or more items, along with quantity desired, so that others may see and purchase items for the user.

The user may see a “best” price for the item across the Internet and not just from a single merchant or single site. The user may also see a list of “best” prices from different merchants and locations so that the user can select what is “best” or most desirable for the user, including if and where the item is available for local pick up. The system may determine user preferences, such as sizes, colors, and other item features, from previous purchases, so that when items are returned, they include “desired” or previously purchased user features.

A list of saved items of interest may be shown on a single page from different online merchants. The list or display of items may show items that have been placed in a cart to be purchased, have already been purchased, or are still waiting for possible purchase. The user may drag and drop or otherwise place individual items on the display in a single cart on a user display. The single cart may show all selected items with the site or merchant that is offering the item. Once ready for purchase, the user may see a pre-populated screen of a shipping address, shipping option, and funding source, which the user can edit if desired.

With an item or list that is shared from another, the user may select a desired item from the list for purchase. The user may then see a pre-populated screen showing the recipient name and shipping address (such as of the person who shared the list with the user). The user may also be sent notifications, such as through text, when the item is available at or below a certain user-specified price.

In some embodiments, a user may express interest in an item. The system can search for best deals for that item across the web, including any coupons that can be applied. Deals may be color-coded to help visualize best deals. The user can also indicate that a particular item is too expensive, but wants to see less expensive similar items, look-alikes, and/or knock-offs, and the system will return such a list to the user.

The service provider may also provide information to merchants to help them provide more useful offers or recommendations to users and increase the likelihood of a sale. The information may include some or all aspects and examples of the susceptibility profiles discussed herein (user data, transaction drivers and so forth). Such information can include data such as how long a user looks at an item, whether that item is purchased or held (and for how long), the price paid or looked at, items shared, liked, disliked, added, deleted, too expensive, etc., may be compiled and presented to the merchant in easy to digest formats to allow the merchant to make changes to offerings, generally or specific to a user. Information may be merchant specific, item specific, category specific, or any other suitable breakdown.

The service provider may also provide susceptibility profile information when multiple users are looking at a specific merchant item or offering, a specific item from different merchants, and/or similar items from one or more merchants. The price viewed for the item is also noted. Based on the price point the user is looking at or prices the user has paid for or previously looked at for the item or similar item, the merchant can use information to send an offer to users currently interested in the item or a similar item from the merchant or different merchants. This allows the merchant an opportunity to make multiple sales quickly on an item by pricing it to an acceptable level to users.

### Susceptibility Profile Intelligence Through Payment Service Provider (e.g., PayPal) Identity

In some embodiments, the susceptibility profile module 212 may use custom algorithms that predict object aesthetics and preferences based on information gleaned from informatics mining across merchant or service provider data and as facilitated by user log in.

An identity provider (IDP) product may utilize OpenID and OAuth protocols to authenticate a user with a merchant website. In one example, once a consumer uses PayPal Access to engage with a marketplace, a specific profile, known as the susceptibility profile, may be created as part of the user data set. This information may be seeded from interpretations on the data that already exist in the user's merchant or service provider data set.

It is contemplated that any of the features and/or embodiments discussed herein may be combined or incorporated into any of the other features and/or embodiments.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

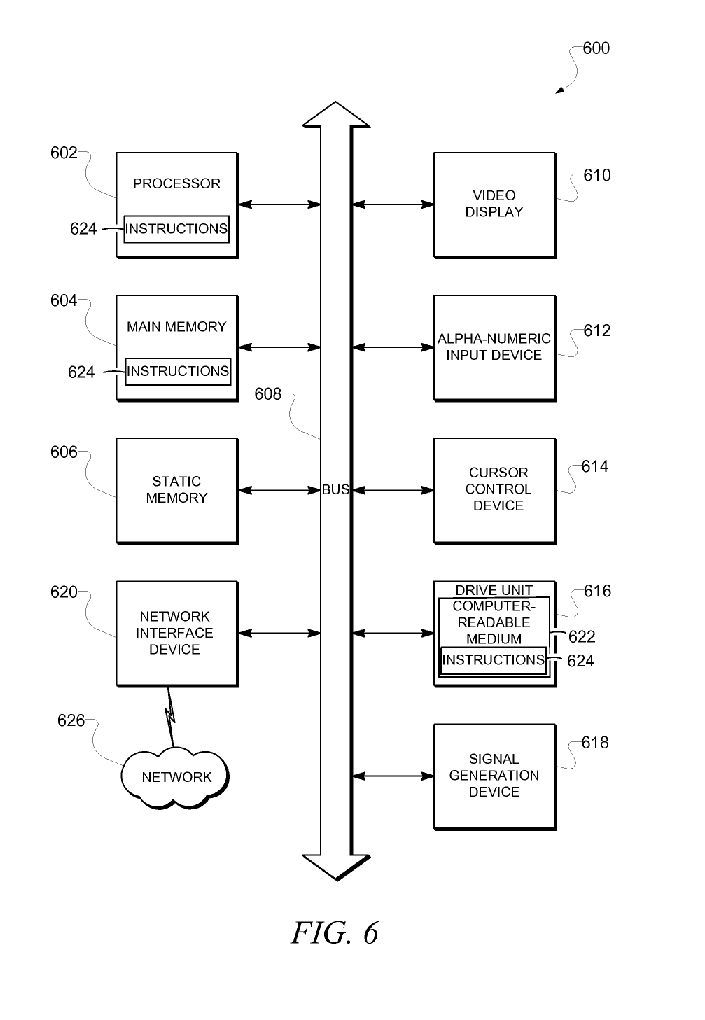

FIG. 6 is a block diagram of a machine in the example form of a computer system 600 within which instructions 624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
collecting transaction data relating to a plurality of participants performing transactions in a marketplace environment;
identifying at least one transaction driver associated with an identified section of the transactions;
based on the identified at least one transaction driver, creating a susceptibility profile for a participant in the marketplace environment, the susceptibility profile including participant-related data pertaining to the at least one identified transaction driver;
receiving a request from the participant to search for an item for sale in the marketplace environment; and
causing a presentation to the participant of items for sale satisfying the susceptibility profile of the participant.

2. The method of claim 1, wherein the susceptibility profile of the participant includes participant-related data pertaining to one or more of: a price threshold; a discount threshold; a budget limit; a delivery service; an available balance at a payment service provider; a payment cycle; a geographic location; a product or service configuration; a request to remove an item from a shopping cart; feedback received regarding an item previously purchased; and a browsing history.

3. The method of claim 1, further comprising:
receiving a request from a first participant to place an item for sale in the marketplace environment;
receiving from the first participant a minimum price for the item;
causing a presentation of the item in the marketplace environment at a sales price based on the susceptibility profile of at least one second participant;
receiving a request from the at least one second participant to purchase the item; and
apportioning a payment to the first participant based on a portion or all of a difference between the sales price and the minimum price.

4. A system comprising a machine having a memory and at least one processor, and at least one hardware-implemented module, executable by the machine, to:
collect transaction data relating to a plurality of participants performing transactions in a marketplace environment;
identify at least one transaction driver associated with an identified section of the transactions;
based on the identified at least one transaction driver, create a susceptibility profile for a participant in the marketplace environment, the susceptibility profile including participant-related data pertaining to the at least one identified transaction driver;
receive a request from the participant to search for an item for sale in the marketplace environment; and
cause a presentation to the participant of items for sale satisfying the susceptibility profile of the participant.

5. The system of claim 4, wherein the susceptibility profile of the participant includes participant-related data pertaining to one or more of: a price threshold; a discount threshold; a budget limit; a delivery service; an available balance at a payment service provider; a payment cycle; a geographic location; a product or service configuration; a request to remove an item from a shopping cart; feedback received regarding an item previously purchased; and a browsing history.

6. The system of claim 4, wherein the least one hardware-implemented module is further to:
receive a request from a first participant to place an item for sale in the marketplace environment;
receive from the first participant a minimum price for the item;
cause a presentation of the item in the marketplace environment at a sales price based on the susceptibility profile of at least one second participant;
receive a request from the at least one second participant to purchase the item; and
apportion a payment to the first participant based on a portion or all of a difference between the sales price and the minimum price.

7. A non-transitory machine-readable medium including a set of instructions that, when executed by at least one processor, causes the at least one processor to perform a set of operations comprising:
collecting transaction data relating to a plurality of participants performing transactions in a marketplace environment;
identifying at least one transaction driver associated with an identified section of the transactions;
based on the identified at least one transaction driver, creating a susceptibility profile for a participant in the marketplace environment, the susceptibility profile including participant-related data pertaining to the at least one identified transaction driver;
receive a request from the participant to search for an item for sale in the marketplace environment; and
cause a presentation to the participant of items for sale satisfying the susceptibility profile of the participant.

8. The medium of claim 7, wherein the susceptibility profile of the participant includes participant-related data pertaining to one or more of: a price threshold; a discount threshold; a budget limit; a delivery service; an available balance at a payment service provider; a payment cycle; a geographic location; a product or service configuration; a request to remove an item from a shopping cart; feedback received regarding an item previously purchased; and a browsing history.

9. The medium of claim 7, wherein the set of operations further comprise:
receiving a request from a first participant to place an item for sale in the marketplace environment;
receiving from the first participant a minimum price for the item;
causing a presentation of the item in the marketplace environment at a sales price based on the susceptibility profile of at least one second participant;
receiving a request from the at least one second participant to purchase the item; and
apportioning a payment to the first participant based on a portion or all of a difference between the sales price and the minimum price.
